(19) United States
(12) Patent Application Publication
(10) Pub. No.: US 2001/0002276 A1
(43) Pub. Date: May 31, 2001

(54) MANUFACTURING METHOD OF MAGNET RESIN COMPOUND

(76) Inventor: FUMITOSHI YAMASHITA, IKOMA-SHI (JP)

Correspondence Address: PARKHURST AND WENDEL, 1421 PRINCE STREET, SUITE 210, ALEXANDRIA, VA, 223142805

(21) Appl. No.: 09/217,832

(22) Filed: Dec. 22, 1998

(30) Foreign Application Priority Data
Dec. 26, 1997 (JP) 9-359591

(51) Int. Cl. B05D 7/00; B05D 3/12

(52) U.S. Cl. 427/215; 427/216; 427/220; 427/221

(57) ABSTRACT

Fine powder out of adequate particle size range discharged in a manufacturing process of resin magnet compound comprising step 1 of mixing magnet powder such as neodymium-iron-boron system quenched alloy and an organic solvent solution of a thermal polymerizing resin in wet process, and step 2 of solvent removal-pulverizing-sorting into adequate particle size range is processed again in step 1 and step 2, and resin magnet compound within adequate particle size range is obtained again, and moreover the green matter obtained by strong compression of the resin magnet compound into a desired magnet shape is processed again at step 2 to obtain fine powder, which is processed again at step 1 and step 2, so that resin magnet compound within adequate particle size is obtained again.

### FIELD OF THE INVENTION

The present invention relates to a manufacturing method of resin magnet compound, and more particularly to a manufacturing method of resin magnet compound capable of regenerating resin magnet compound, green material and others out of the standard occurring in the manufacturing stage of neodymium-iron-boron system quenched resin magnet.

### BACKGROUND OF THE INVENTION

Prior arts relating to a compound of rare earth magnet powder and resin include one disclosed, for example, in Japanese Laid-open Patent No. 59-136907. This prior art presents:

1. A manufacturing method of samarium-cobalt system magnet using a thermoplastic resin by injection molding method, in which by using R₂TM₁₇ (where R is a rare earth element such as samarium and TM is a transition metal, or mainly cobalt) as samarium-cobalt system magnet powder, as compared with the case of using RCo₅, the injection-molded magnet, or the compound of rare earth magnet powder such as sprue or runner and resin composition can be more easily ground to be presented again for injection molding.

2. It is easier to handle by demagnetizing the injection-molded magnet or sprue or runner of molded piece.

3. When the material regenerated from the injection-molded magnet or the sprue or runner of molded piece is mixed with a kneaded material, lowering of magnetic performance or mechanical properties can be suppressed. It is hence an object thereof to manufacture the samarium-cobalt system resin magnet efficiently in an industrial scale by injection molding.

It is, however, known well that the samarium-cobalt system magnet powder is inferior in resource balance because samarium and cobalt are much contained.

In the case of the magnet being manufactured by injection molding, the sprue and runner occupy 80 to 90% of the entire molded piece of the magnet in a small magnet weighing not more than several grams as the one used in the driving source of peripheral device for multimedia PC (personal computer) or the like, and the materials such as samarium-cobalt system magnet powder and thermoplastic resin are spent wastefully in the non-usable parts such as sprue and runner rather than the magnet main body, and energy and materials for injection molding are consumed, which is not preferable from the viewpoint of saving energy and saving resources. Moreover, for injecting the kneaded plastic fused strands to fill in the molding die cavity, the mixing rate of the samarium-cobalt system magnet powder must be 65 vol. % or less. However, keeping the mixing rate of the magnet powder at 65% or less is not advantageous from the standpoint of seeking the magnetic performance for making the best of the magnetic potential of the rare earth magnet.

To increase the volume percentage of the samarium-cobalt system magnet powder and make the best of the magnetic potential of the rare earth magnet powder, it is advantageous to compress the rare earth magnet powder strongly together with thermal polymerizing resin such as epoxy resin because the sprue and runner are not required and the magnetic performance is enhanced.

In the prior art, however, nothing has been known about the technique for compressing the rare earth magnet powder including samarium-cobalt system magnet powder strongly in a specified magnet shape together with thermal polymerizing resin such as epoxy resin.

On the other hand, seeing from the present situation of mass use of rare earth resin magnet in the driving source of peripheral device of multimedia PC or the like, it is desired to save resources by using neodymium-iron-boron system quenched magnet powder having an alloy composition excellent in resource balance as compared with the samarium-cobalt system magnet powder, and reduce the disposal amount of magnet materials by reusing the resin magnet compound of rare earth magnet powder and thermal polymerizing resin.

The invention therefore relates to the neodymium-iron-boron system quenched resin magnet excellent in resource balance of alloy composition as compared with the samarium-cobalt system magnet powder, and used in quantities in the driving source of peripheral device of multimedia PC or the like, and more particularly to a manufacturing method of green matter formed by strongly compressing neodymium-iron-boron system quenched magnet powder resin compound, and a manufacturing method for reusing the resin magnet compound composed of neodymium-iron-boron system quenched magnet powder and thermal polymerizing resin, so that the disposal amount of the precious magnet material can be reduced.

### SUMMARY OF THE INVENTION

The invention provides a manufacturing method of resin magnet compound comprising step 1 of mixing magnet powder and an organic solvent solution of a thermal polymerizing resin in wet process, and step 2 of solvent removal-pulverizing-sorting into adequate particle size range, in which fine powder out of adequate particle size range discharged at step 2 is granulated within the adequate particle size range after the wet process mixing of step 1 and solvent removal-pulverizing-sorting of step 2, so that the disposal amount of magnet material may be reduced.

### BRIEF DESCRIPTION OF THE DRAWINGS

FIG. 1 is a chemical reaction formula of thermal polymerizing reaction of epoxy oligomer and isocyanate regenerated material.

FIG. 2 is a block diagram showing a regenerating process of neodymium-iron-boron system quenched magnet powder resin compound.

### DESCRIPTION OF THE PREFERRED EMBODIMENTS

As an embodiment of the invention, an example of using neodymium-iron-boron system quenched magnet powder as magnet powder is described below.

The embodiment relates to a manufacturing method of resin magnet compound comprising step 1 of mixing neodymium-iron-boron lo system quenched magnet powder and an organic solvent solution of a thermal polymerizing resin in wet process, and step 2 of solvent removal-pulverizing-sorting into adequate particle size range, in which fine powder out of adequate particle size range discharged at step 2 is processed again by wet process mixing of step 1 and solvent removal-pulverizing-sorting of step 2 to regenerate granular resin magnet compound within adequate particle size range, so that the fine powder out of adequate particle size range can be reused.

Moreover, a granular resin magnet compound is strongly compressed into a desired magnet shape to form a green matter, and this green matter is pulverized and sorted to obtain fine powder, and it is processed again by wet process mixing of step 1 and solvent removal-pulverizing-sorting of step 2, and a granular resin magnet compound within adequate particle size range is obtained once more, so that the green matter formed in an inappropriate shape may be regenerated and used.

The following measures are effective so as not to spoil the performance and quality of neodymium-iron-boron system quenched resin magnet.

1. The amount of fine powder to be added is 25 parts or less by weight to 100 parts by weight in total of neodymium-iron-boron system quenched magnet powder and thermal polymerizing resin to be mixed by wet process.

2. More than 50 wt. % of this fine powder is 38 μm or more in particle size.

3. The thermal polymerizing resin is mainly composed of one kind or two or more kinds of polymer having a functional group capable of reacting with an isocyanate group in its molecular chain, and isocyanate regenerated material.

4. As the polymer having a functional group capable of reacting with an isocyanate group in its molecular chain, diglycidyl ether bisphenol A with melting point of 90±5° C. is used.

5. The isocyanate regenerated material has a structure of blocking the isocyanate group of 4-4′-diphenyl methane diusocyanate by methyl ethyl ketone oxime.

(Embodiments)

Recently, neodymium-iron-boron system quenched resin magnets of a relatively small shape are massively used as key members of motors and actuators such as spindle motor and stepping motor wide used as driving sources of multimedia PC peripheral devices. The invention relates to such neodymium-iron-boron system quenched resin magnet, and more particularly to regeneration of resin magnet compound of neodymium-iron-boron system quenched magnet powder such as granular resin compound and green matter in the magnet manufacturing state, and a thermal polymerizing resin.

The neodymium-iron-boron system quenched magnet powder in the invention is manufactured, for example as disclosed in J. F. Herbest, “Rare Earth-Iron-Boron Materials: A New Era in Permanent Magnets,” Ann. Rev. Sci., Vol. 16 (1986), by quenching and solidifying a molten alloy containing Nd:Fe:B nearly at a rate of 2:14:1, and heating properly to crystallize in a phase of Nd₂Fe₁₄B in crystal particle size of 20 to 100 nm. Generally, the residual magnetizing Jr is 8 kG and the intrinsic coercive force Hcj is 8 kOe or more. However, since the quenched and solidified alloy of neodymium-iron-boron system is a so-called flake powder of 20 to 30 μm in thickness, and this powder must be formed into a desired magnet shape by some method or other in order to use as a general magnet. The means of forming the neodymium-iron-boron system quenched magnet powder into a desired shape is generally means of kneading together with thermal polymerizing resin such as epoxy resin, compressing strongly to form into a green matter, and thermally polymerizing this formed material into a resin magnet.

Incidentally, the thermal polymerizing resin such as epoxy resin is slightly progressed in the polymerizing reaction even at room temperature. As a result, it is gradually thickened and is finally gelated. A gelated epoxy resin cannot be formed into neodymium-iron-boron system quenched magnet powder. Therefore, the thermal polymerizing resin for forming the neodymium-iron-boron system quenched magnet powder is desired not to polymerize at room temperature, and to be cured quickly in thermal polymerization.

The thermal polymerizing resin in the invention is mainly composed of one kind or two or more kinds of polymer having a functional group capable of reacting with an isocyanate group in its molecular chain, and isocyanate regenerated material. Herein, the functional group capable of reacting with an isocyanate group includes, among others, —OH, —COOH, —NHCO—, —NHCOO—, —NHCONH, —SH, —CHS, —CSOH, and active methylene. Any polymer having any one of these functional groups may be used, and more preferably the polymer is desired to have —OH, —NHCO—, —NHCOO—, or —NHCONH in the molecular chain. Examples of polymer having -alcoholic—OH group in the molecular chain include epoxy, phenol, urethane, urea and other oligomers, polyether, polyether ester, polyester imide, and other polymers, and more preferably it should be a diglycidyl ether bisphenol A type epoxy oligomer with thermal softening temperature of 90±5° C., expressed in the following formula, obtained by reaction condensation of epichlorohydrin and bisphenol A. Herein, the thermal softening temperature is defined at 90±5° C. because, if the softening temperature is lower, the apparent density and flowability of the neodymium-iron-boron system quenched magnet powder-resin compound are changed in the room temperature region below 45° C., or if the softening temperature is higher, it is hard to obtain a green matter of high density.

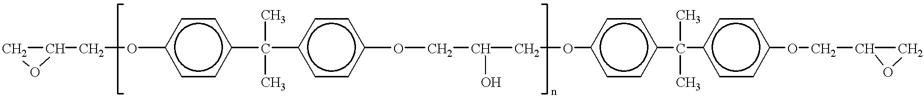

In the formula, —C(CH₃)₂— of bisphenol A may be replaced also by —O—, —S—, —SO—, —SO2—, —CH₂—, —(CH₂)₂—, or the like.

The isocyanate regenerated material is an organic compound called block isocyanate or stabilized isocyanate, which is obtained by stabilizing polyisocyanate having an isocyanate group by a compound having an alcoholic —OH group in its molecule. Herein, examples of polyisocyanate include 2-4 tolylene diisocyanate, 2-6 tolylene diisocyanate, cyclopentylene diisocyanate, m-phenylene diisocyanate, p-phenylene diisocyanate, ethylene diisocyanate, butylidene diisocyanate, 1-5 naphthalene diusocyanate, 1-6 hexamethylene diisocyanate, 4-4′ diphenyl methane diisocyanate, 4-4′ diphenyl ether diisocyanate, xylene diisocyanate, or other diisocyanates, and diisocyanate compounds of valence of 3 or more, for example, cyclic trimer of 2-4 tolylene diisocyanate, cyclic trimer of 2-6 tolylene diisocyanate, and trimer of 4-4′ diphenyl methane diisocyanate.

The compound for stabilizing the isocyanate group of these organic compounds is realized, for example, by aliphatic alcohols such as methyl alcohol, ethyl alcohol, n-propyl alcohol, iso-propyl alcohol, and n-butyl alcohol, alicyclic alcohols such as cyclohexyl alcohol and 2-methyl hexyl alcohol, monovalent alcohols such as benzyl alcohol, phenyl cellosolve, and furfuryl alcohol, and polyhydric alcohol derivatives such as ethylene glycol monoethyl ether, ethylene glycol isopropyl ether, and ethylene glycol monobutyl ether. Aside from these alcohols, examples of the compound for stabilizing the isocyanate group include phenol, cresol, xylenol, p-ethol phenol, o-isopropyl phenol, p-t butyl phenol, p-t octyl phenol, p-catechol, resorcinol, other phenols, and also other active methylene compounds such as dimethyl malonate, diethyl malonate, acetoacetic methyl, acetoacetic ethyl, and methyl ethyl ketone oxime.

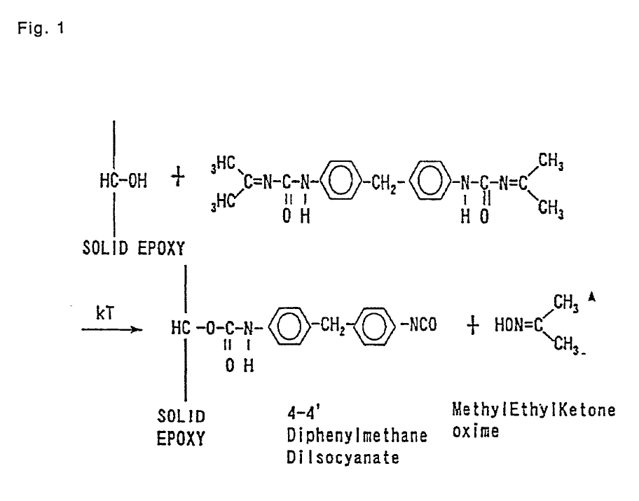

FIG. 1 shows a thermal polymerizing reaction formula of the epoxy oligomer and isocyanate regenerated material.

In the thermal polymerizing reaction of the thermal polymerizing resin of epoxy oligomer and 4-4′ diphenyl methane diisocyanate blocked by methyl ethyl ketone oxime, first, the methyl ethyl ketone oxime of the isocyanate regenerated material is thermally dissociated (140° C. or higher), and the isocyanate group of the liberated 4-4′ diphenyl methane diisocyanate is quickly polymerized with the alcoholic OH group in the molecular chain of the epoxy oligomer to form an insoluble and infusible three-dimensional network structure, so that the neodymium-iron-boron system quenched magnet powder is firmly fixed.

On the other hand, the neodymium-iron-boron system quenched magnet powder does not promote dissociation of methyl ethyl ketone oxime. Therefore, the neodymium-iron-boron system quenched magnet powder-resin compound of the invention is not changed in the molecular weight of the resin component and is not gelated if let stand in room temperature region for more than 5 years.

The invention relates to a manufacturing method of a granular resin magnet compound composed of 2-3 wt. % of thermal polymerizing resin of epoxy oligomer and 4-4′ diphenyl methane diisocyanate blocked by methyl ethyl ketone oxime which is hardly polymerized in room temperature region as mentioned above, and 97-98 wt. % of neodymium-iron-boron system quenched magnet powder with specific surface area of 0.05 m²/g and true density of 7.55 g/cm³, and a green matter obtained by compressing it strongly.

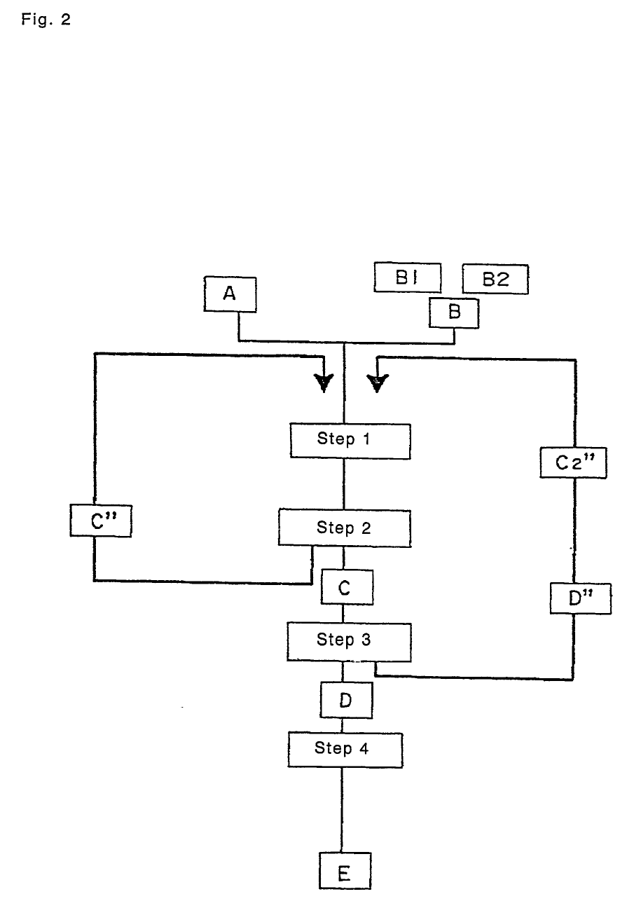

FIG. 2 is a process diagram showing the manufacturing method in an embodiment of the invention. In FIG. 2, reference symbol A denotes neodymium-iron-boron system quenched magnet powder, and B1 is a polymer having a functional group capable of reacting with an isocyanate group in its molecular chain, for example, diglycidyl ether bisphenol A type epoxy oligomer with thermal softening temperature of 90±5° C. Reference symbol B2 denotes an isocyanate regenerated matter, for example, an isocyanate regenerated matter having the isocyanate group of 4-4′ diphenyl methane diusocyanate blocked by methyl ethyl ketone oxime. Reference symbol B denotes an organic solvent solution of thermal polymerizing resin containing the oligomer B1 and isocyanate regenerated matter B2. Herein, the organic solvent is a general solvent such as acetone, methyl ethyl ketone, or methyl isobutyl ketone.

Further, step 1 is a wet process mixing step of magnet powder A and thermal polymerizing resin solution B, and step 2 is a step of solvent removal-pulverizing-sorting the mixture obtained at step 1 into adequate particle size range, and forming a granular resin magnet compound C. Next step 3 is a step of compressing the granular resin magnet compound within the adequate particle size range strongly into a specified magnet shape to form a green matter D. Step 4 is a step of curing the thermal polymerizing resin to obtain a neodymium-iron-boron system quenched resin magnet E.

The granular resin magnet compound C obtained at step 2 is strongly compressed into a specified magnet shape at step 3 to obtain the green matter D. At this time, in order to assure the density and dimensional precision of the green matter, for example as disclosed in Japanese Laid-open Patent No. 63-194312, more than 50 wt. % of the granular resin magnet compound C is required to be 75 μm or more in particle size. However, those exceeding the adequate particle size range can be directly pulverized and sorted again at step 2, but generation of fine powder C″ below particle size of 75 μm, especially below particle size of 53 μm cannot be prevented.

Further, when obtaining the green matter D by strongly compressing the granular resin magnet compound C within the adequate particle size range into a specified magnet shape at step 3, generation of green matter D″ not satisfying the necessary conditions as the neodymium-iron-boron system quenched resin magnet E cannot be prevented due to changes of magnet shape, adjustment of compression condition, apparatus operating condition or other problems.

The invention is intended to transform the fine powder C″ into the granular resin magnet compound C within the adequate particle size range again after step 1 of wet process mixing and step 2 of solvent removal-pulverizing-sorting, and more particularly the green matter D out of the standard generated by strong compression of the compound C into a desired magnet shape is pulverized and sorted same as at step 2 to produce fine powder C2″, and is formed into granular resin magnet compound in the adequate particle size range again through step 1 of wet process mixing and step 2 of solvent removal-pulverizing-sorting.

Moreover, so as not to spoil the performance and quality of the neodymium-iron-boron system quenched resin magnet, fine powder C″ or fine powder C2 by pulverizing the green matter D″ is added by 25 parts by weight or less to 100 parts by weight of the sum of the neodymium-iron-boron system quenched magnet powder and thermal polymerizing resin to be mixed by wet process. The reason is to suppress lowering of powder molding performance (flowability, apparent density) of the regenerated granular resin magnet compound C and density or mechanical strength of the obtained green matter D. Besides, more than 50 wt. % of the fine powder C″ or C2″ must be 38 μm or more in the particle size.

This is because if the fine powder having the particle size of 38 μm or less is present by more than 50 wt. %, a step is caused in the 4 πI-H curve of the magnet, which may lead to lowering of magnetic flux amount at the operation point or lowering of demagnetization resistance to inverse magnetic field.

The manufacturing method of the invention including the regeneration step of resin magnet compound is further described below while referring to FIG. 2.

In FIG. 2, reference symbol A is neodymium-iron-boron system quenched magnet powder of alloy composition Nd₁₂Fe(balance)Co₅B₆ occupying 97.5 wt. % in material mixture 100 of resin magnet compound, and B is an acetone solution containing 2.5 wt. % of epoxy resin composed of diglycidyl ether bisphenol A type epoxy oligomer (B1) with thermal softening temperature of 90±5° C. and isocyanate regenerated material (B2) having the isocyanate group of 4-4′ diphenyl methane diusocyanate blocked by methyl ethyl ketone oxime.

Step 1 is a wet process mixing step of magnet powder A and resin solution B in a batch of 10 kg, and step 2 is a step of solvent removal-pulverizing-sorting the mixture obtained at step 1 into adequate particle size range (53 to 250 μm) to obtain granular resin magnet compound C. Next step 3 is a step of compressing strongly the granular resin magnet compound C within the adequate particle size range into a specified magnet shape to obtain green matter D. Step 4 is a step of forming neodymium-iron-boron system quenched resin magnet E by curing the thermal polymerizing resin.

In the granular resin magnet compound C obtained at step 2, fine powder C″ of 53 μm or less in particle size is mixed and discharged by about 2%. Further at step 3, material out of standard of the neodymium-iron-boron system quenched resin magnet E is discharged by about 0.1%.

In the invention, the fine powder C″ of 53 μm or less in particle size is processed again at step 1 of wet process mixing and step 2 of solvent removal-pulverizing-sorting, and granular resin magnet compound C within adequate particle size range is obtained. The green matter D out of the standard generated by strong compression of the resin magnet compound C into a desired magnet shape is pulverized and sorted same as at step 2, and fine powder C2″ of 150 μm or less in particle size is obtained, and it is repeatedly processed at step 1 of wet process mixing and step 2 of solvent removal-pulverizing-sorting, and granular resin magnet compound C within adequate particle size range is obtained again.

Table 1 is a characteristic table showing the results of measurement of flowability (JIS Z 2502) and apparent density (JIS Z 2504) of the granular resin magnet compound C obtained by varying the mixing rate of the fine powder C″ when granular resin magnet compound C within adequate particle size range is obtained again by processing the fine powder C″ of 53 μm or less in particle size by step 1 of wet process mixing and step 2 of solvent removal-pulverizing-sorting, and pressure ring strength, density (Archimedean method), and magnetic characteristics (after 50 kOe pulse magnetization: measured magnetic field ±25 kOe: VSM) of the resin magnet E by thermal polymerization of green matter D obtained by strong compression at 8 tons/cm² at 160° C. for 5 minutes.

TABLE 1

| | | | | | | Comparative |
|---|---|---|---|---|---|---|
| Fine powder C″ | Prior art | Invention | | | | example |
| content, wt. % | 0 | 10 | 15 | 20 | 25 | 30 |
| Flowability s/50 g | 42.1 | 42.22 | 43.4 | 42.5 | 42.6 | 48.9 |
| Apparent density | 2.72 | 2.70 | 2.75 | 2.74 | 2.78 | 3.01 |
| g/cm³ | | | | | | |
| Pressure ring strength | 4.60 | 4.53 | 4.55 | 4.51 | 4.41 | 3.82 |
| kgf/mm² | | | | | | |
| Resin magnet density | 5.99 | 6.01 | 6.01 | 5.98 | 5.97 | 5.78 |
| g/cm³ | | | | | | |
| Intrinsic coercive force | 9.10 | 9.23 | 9.10 | 9.09 | 9.05 | 8.76 |
| H_{CJ}/kOe | | | | | | |
| Residual | 7.11 | 7.07 | 7.00 | 6.97 | 6.93 | 6.43 |
| magnetization Br/kG | | | | | | |
| Maximum energy | 9.87 | 9.88 | 9.79 | 9.55 | 9.47 | 8.25 |
| product MGOe | | | | | | |

As clear from Table 1, the invention can manufacture the neodymium-iron-boron system quenched magnet powder-resin compound maintaining the same molding performance as in the prior art without containing fine powder C″ and neodymium-iron-boron system quenched resin magnet having the same magnetic characteristic and mechanical strength as the performance of the prior art.

Table 2 is a characteristic table showing the results of measurement of flowability (JIS Z 2502) and apparent density (JIS Z 2504) of the granular resin magnet compound C obtained by varying the mixing rate of the fine powder C2″ when granular resin magnet compound C within adequate particle size range is obtained again by processing the green matter D″ out of the standard generated by strong compression of the compound C into a desired magnet shape by pulverizing and sorting same as at step 2 to obtain fine powder C2″ of 150 μm or less in particle size and processing again at step I of wet process mixing and step 2 of solvent removal-pulverizing-sorting, and pressure ring strength, density (Archimedean method), and magnetic characteristics (after 50 kOe pulse magnetization: measured magnetic field ±25 kOe: VSM) of the resin magnet E by thermal 10 polymerization of green matter D obtained by strong compression at 8 tons/cm² at 160° C. for 5 minutes.

TABLE 2

| | | | | | | Comparative |
|---|---|---|---|---|---|---|
| Fine powder C₂″ | Prior art | Invention | | | | example |
| content, wt. % | 0 | 10 | 15 | 20 | 25 | 30 |
| Flowability s/50 g | 41.9 | 42.6 | 43.5 | 44.2 | 45.1 | 52.8 |
| Apparent density | 2.72 | 2.75 | 2.77 | 2.73 | 2.77 | 3.05 |
| g/cm³ | | | | | | |
| Pressure ring strength | 4.61 | 4.56 | 4.52 | 4.51 | 4.25 | 3.67 |
| kgf/mm² | | | | | | |
| Resin magnet density | 5.99 | 6.00 | 6.02 | 6.00 | 6.01 | 5.83 |
| g/cm³ | | | | | | |
| Intrinsic coercive force | 9.10 | 9.05 | 9.12 | 9.11 | 9.06 | 8.60 |
| H_{CJ}/kOe | | | | | | |
| Residual | 7.11 | 7.05 | 7.12 | 7.02 | 7.03 | 6.41 |
| magnetization Br/kG | | | | | | |
| Maximum energy | 9.87 | 9.82 | 9.90 | 9.86 | 9.76 | 8.18 |
| product MGOe | | | | | | |

As clear from Table 2, the embodiment can manufacture the neodymium-iron-boron system quenched magnet powder-resin compound maintaining the same molding performance as in the prior art without containing fine powder C2″ and neodymium-iron-boron system quenched resin magnet having the same magnetic characteristic and mechanical strength as the performance of the prior art.

As evident from the embodiment, the invention can reduce the disposable amount of the product out of the standard generated when molding the resin magnet compound and resin magnet, and its industrial value is outstanding.

What is claimed is:

1. A method of manufacturing resin magnet compound comprising the steps of:
(1) mixing magnet powder and an organic solvent solution of a thermal polymerizing resin in wet process; and
(2) removing solvent, pulverizing and sorting into adequate particle size range,
wherein fine powder of resin magnet compound out of adequate particle size range discharged at the step (2) is processed again by the step (1) and step (2), so that resin magnet compound within adequate particle size range is obtained.

2. A method of manufacturing resin magnet compound comprising the steps of:
(1) mixing magnet powder and an organic solvent solution of a thermal polymerizing resin in wet process; and
(2) removing solvent, pulverizing and sorting into adequate particle size range,
wherein resin magnet compound within adequate particle size range is produced by applying the steps of (a) compressing the granular resin magnet compound obtained by performing the step (1) and step (2) into green matter having a magnet shape, (b) pulverizing the green matter out of a predetermined standard and sorting the resulting pulverized powder, and (c) performing again the step (1) and step (2) by using the sorted fine powder.

3. A method of manufacturing resin magnet compound according to claim 1 or 2, wherein an amount of the fine powder to be added is 25 parts or less by weight to 100 parts by weight in total of magnet powder and thermal polymerizing resin.

4. A method of manufacturing resin magnet compound according to claim 1 or 2, wherein 50 wt. % or more of the fine powder is 38 μm or more in particle size.

5. A method of manufacturing resin magnet compound according to claim 1 or 2, wherein the thermal polymerizing resin is mainly composed of one kind or two or more kinds of polymer having a functional group capable of reacting with an isocyanate group in its molecular chain, and isocyanate regenerated material.

6. A method of manufacturing resin magnet compound according to claim 5, wherein the polymer having a functional group capable of reacting with an isocyanate group in its molecular chain is diglycidyl ether bisphenol A with melting point of 90±5° C.

7. A method of manufacturing resin magnet compound according to claim 5, wherein the isocyanate regenerated material has a structure of blocking the end isocyanate group of 4-4′-diphenyl methane diisocyanate by methyl ethyl ketone oxime.
